(19) United States
(12) Patent Application Publication
(10) Pub. No.: US 2013/0335378 A1
(43) Pub. Date: Dec. 19, 2013

(54) TOUCH DEVICE

(71) Applicants: Tzyy-Pyng Lin, New Taipei City (TW); Fu-Kuei Chang, New Taipei City (TW); Jhih-Wun Syu, Sinjhuang City (TW); Kuei-Ying Chan, Sinjhuang City (TW)

(72) Inventors: Tzyy-Pyng Lin, New Taipei City (TW); Fu-Kuei Chang, New Taipei City (TW); Jhih-Wun Syu, Sinjhuang City (TW); Kuei-Ying Chan, Sinjhuang City (TW)

(21) Appl. No.: 13/525,705

(22) Filed: Jun. 18, 2012

(51) Int. Cl. G06F 3/042; G06F 3/041

(52) U.S. Cl. 345/175; 345/173

(57) ABSTRACT

A touch device includes a frame body, multiple first transmitters, multiple first receivers, multiple second transmitters, multiple second receivers and a connection unit. The frame body has a first side, a second side, a third side and a fourth side. Two ends of the first and third sides are respectively connected to the second and fourth sides. The first transmitters are disposed on the first side and the first receivers are disposed on the third side corresponding to the first transmitters to together define a horizontal detection area. The second transmitters are disposed on the second side and the second receivers are disposed on the fourth side corresponding to the second transmitters to together define a vertical detection area. A terminal of the connection unit is electrically connected to the first and second transmitters and receivers. The horizontal and vertical detection areas together form a three-dimensional detection area.

### BACKGROUND OF THE INVENTION

1. Field of the Invention

The present invention relates to a touch device having a three-dimensional detection area. By means of the three-dimensional detection area, a user can input the commands and complete the touch operation without using extra touch strength.

2. Description of the Related Art

In the modern information society, the reliance of peoples on electronic products has more and more increased. Various electronic handheld devices such as cellular phones, handheld computers, personal digital assistants and intelligent cellular phones can be seen everywhere in our daily life. In order to more conveniently and humanly operate the information products and make the information products more lightweight and miniaturized, many information products have employed touch panels as input units instead of the conventional keyboards or mice. The touch panels can be mounted on various plane displays to enable the plane displays to display pictures as well as serve as an operation command input unit.

Please refer to FIG. 1, which is a schematic diagram of a conventional touch device. The conventional touch device includes a substrate, multiple transmitters and multiple receivers arranged on the periphery of the substrate.

The transmitters and receivers are one-to-one arranged to form an infrared touch matrix. According to such arrangement, a mass of LED module transmitters and receivers are needed. Please refer to FIG. 2. Another type of conventional touch panel detection device employs a receiver to receive infrared rays transmitted from multiple transmitters. The multiple transmitters transmit the infrared rays in sequence for the receiver to judge whether the light path is interrupted. Please refer to FIG. 3. Still another type of conventional touch panel detection device employs a transmitter and multiple receivers to form multiple infrared connection lines. In any of the above patterns, an infrared touch array is formed to locate the selective touch position of a user. Such pattern can only provide one single horizontal detection area and can hardly provide a three-dimensional detection area. In addition, when inputting a command via the conventional touch device, a user needs to use an extra touch strength (with his/her finger or a touch pen) for completing the touch operation.

### SUMMARY OF THE INVENTION

It is therefore a primary object of the present invention to provide a touch device having a three-dimensional detection area.

It is a further object of the present invention to provide the above touch device in which by means of the three-dimensional detection area, a user can input the commands and complete the touch operation without using extra touch strength.

To achieve the above and other objects, the touch device of the present invention includes a frame body, multiple first transmitters, multiple first receivers, multiple second transmitters, multiple second receivers and a connection unit. The frame body has a first side, a second side, a third side and a fourth side. The third side is opposite to the first side. Two ends of the first and third sides are respectively connected to the second and fourth sides.

The first transmitters are disposed on the first side and the first receivers are disposed on the third side corresponding to the first transmitters respectively. The first transmitters and the first receivers together define a horizontal detection area.

The second transmitters are disposed on the second side and the second receivers are disposed on the fourth side corresponding to the second transmitters respectively. The second transmitters and the second receivers together define a vertical detection area.

A terminal of the connection unit is electrically connected to the first and second transmitters and receivers.

According to the above touch device, the first receivers are disposed on the third side and the first transmitters are disposed on the first side corresponding to the first receivers respectively. The first transmitters and the first receivers together define a horizontal detection area. The second receivers are disposed on the fourth side and the second transmitters are disposed on the second side corresponding to the second receivers respectively. The second transmitters and the second receivers together define a vertical detection area. The first and second transmitters transmit signals to the first and second receivers in an optical form for the first and second receivers to receive so as to define the horizontal detection area and the vertical detection area and further form the three-dimensional detection area. By means of the three-dimensional detection area, a user can input the commands and complete the touch operation without using extra touch strength.

### BRIEF DESCRIPTION OF THE DRAWINGS

The structure and the technical means adopted by the present invention to achieve the above and other objects can be best understood by referring to the following detailed description of the preferred embodiment and the accompanying drawings, wherein:

FIG. 1 is a schematic diagram of a conventional touch device;

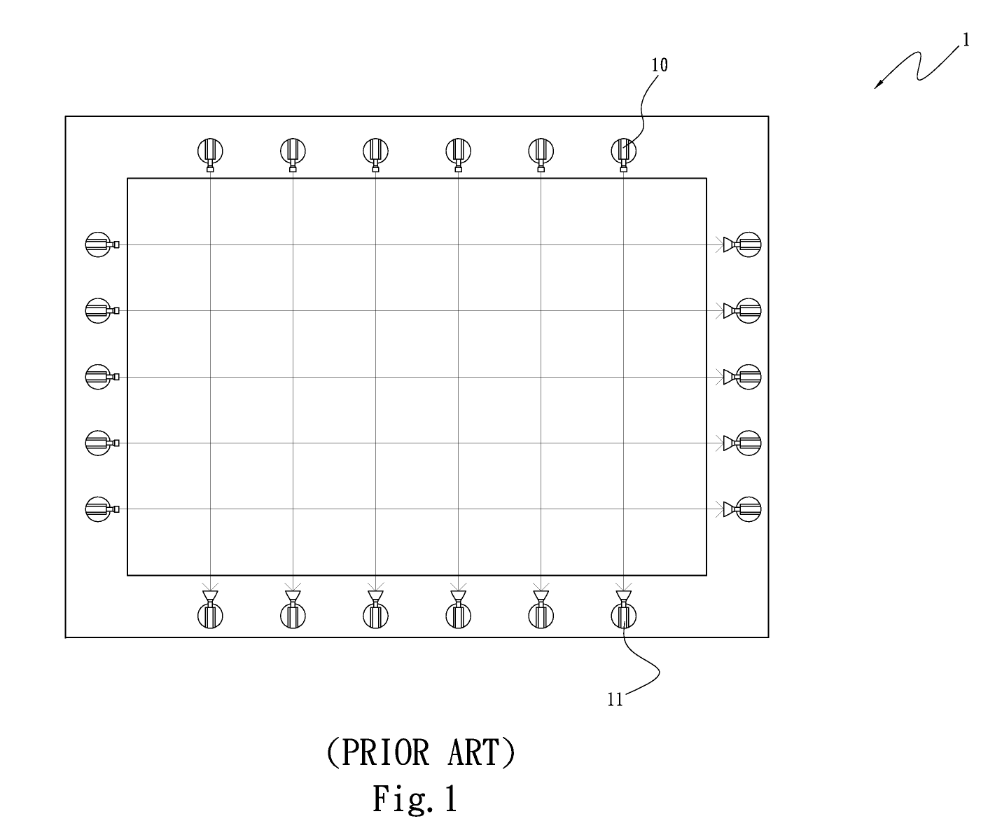

FIG. 2 is a schematic diagram of another type of conventional touch panel detection device;

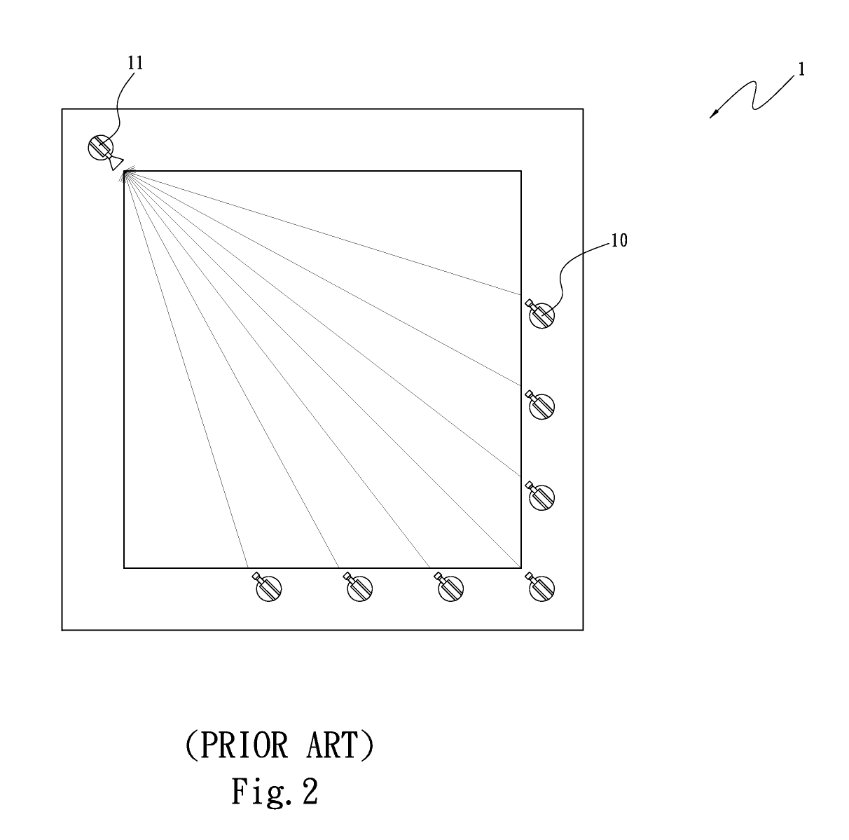

FIG. 3 is a schematic diagram of still another type of conventional touch panel detection device;

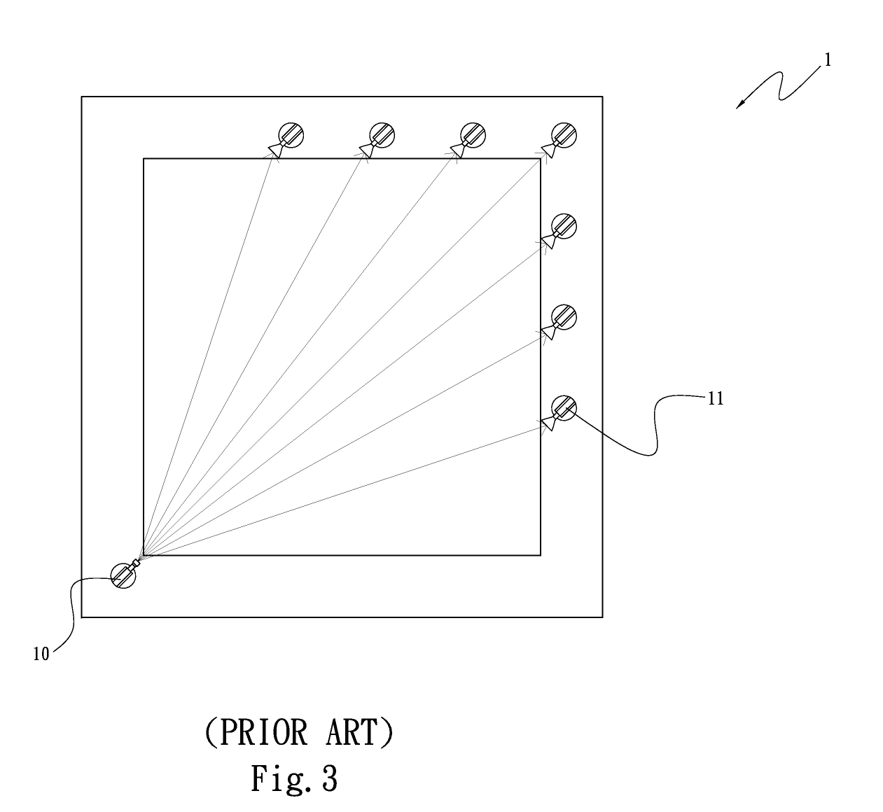

FIG. 4A is a perspective view of a preferred embodiment of the touch device of the present invention; and

FIG. 4B is another perspective view of the preferred embodiment of the touch device of the present invention.

### DETAILED DESCRIPTION OF THE PREFERRED EMBODIMENT

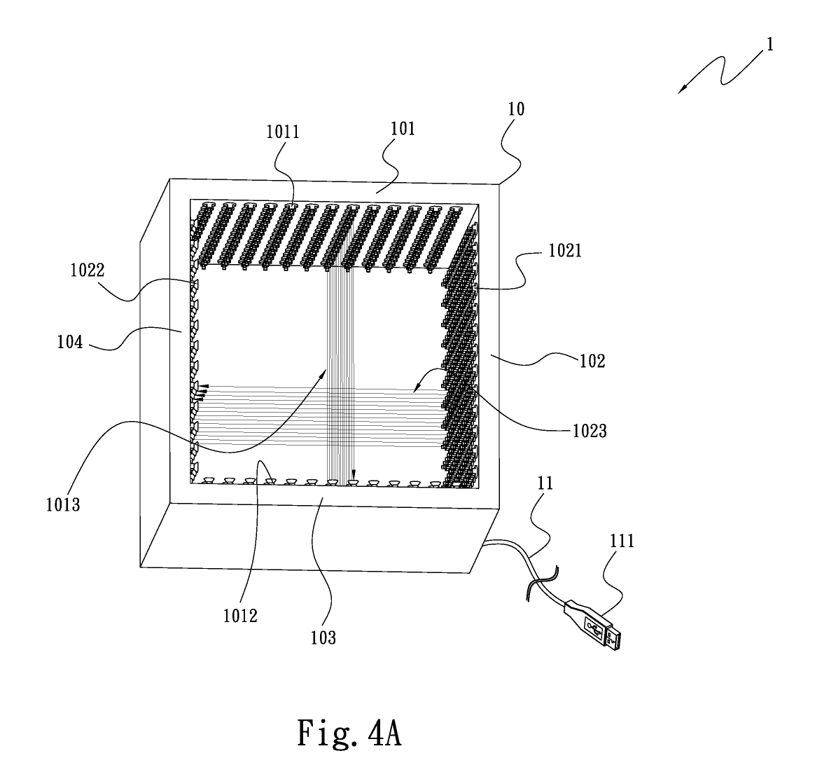

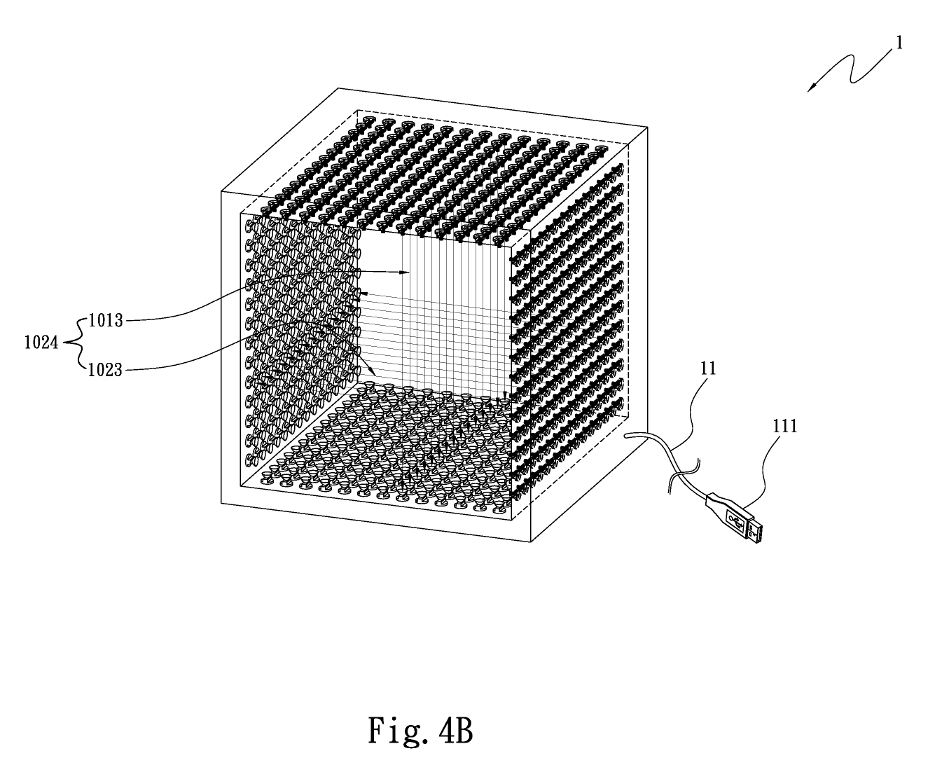

Please refer to FIGS. 4A and 4B. FIG. 4A is a perspective view of a preferred embodiment of the touch device of the present invention. FIG. 4B is another perspective view of the preferred embodiment of the touch device of the present invention. According to the preferred embodiment, the touch device 1 of the present invention includes a frame body 10, multiple first transmitters 1011, multiple first receivers 1012, multiple second transmitters 1021, multiple second receivers 1022 and a connection unit 11. The frame body 10 has a first side 101, a second side 102, a third side 103 and a fourth side 104. The third side 103 is opposite to the first side 101. Two ends of the first and third sides 101, 103 are respectively connected to the second and fourth sides 102, 104.

The first transmitters 1011 are disposed on the first side 101 and the first receivers 1012 are disposed on the third side 103 corresponding to the first transmitters 1011 respectively. The first transmitters 1011 and the first receivers 1012 together define a horizontal detection area 1013. The first transmitters 1011 and the first receivers 1012 are distributed over the first and third sides 101, 103 respectively.

The second transmitters 1021 are disposed on the second side 102 and the second receivers 1022 are disposed on the fourth side 104 corresponding to the second transmitters 1021 respectively. The second transmitters 1021 and the second receivers 1022 together define a vertical detection area 1023. The horizontal detection area 1013 and the vertical detection area 1023 together form a three-dimensional detection area 1024. The second transmitters 1021 and the second receivers 1022 are distributed over the second and fourth sides 102, 104 respectively.

A terminal of the connection unit 11 is electrically connected to the first and second transmitters 1011, 1021 and the first and second receivers 1012, 1022. The connection unit 11 further has a plug-in terminal 111, which is selected from a group consisting of a USB connector, a 1394 connector, an HDMI connector and a digital audio/video connector.

According to the above structure of the touch device, the first and second transmitters 1011, 1021 transmit signals to the first and second receivers 1012, 1022 in an optical form for the first and second receivers 1012, 1022 to receive. The signals in the optical form can be infrared signals. The first receivers 1012 are disposed on the third side 103 and the first transmitters 1011 are disposed on the first side 101 corresponding to the first receivers 1012 respectively. The first transmitters 1011 and the first receivers 1012 together define a horizontal detection area 1013. The second receivers 1022 are disposed on the fourth side 104 and the second transmitters 1021 are disposed on the second side 102 corresponding to the second receivers 1022 respectively. The second transmitters 1021 and the second receivers 1022 together define a vertical detection area 1023. The first and second transmitters 1011, 1021 transmit signals to the first and second receivers 1012, 1022 in an optical form for the first and second receivers 1012, 1022 to receive so as to define the horizontal detection area 1013 and the vertical detection area 1023 and further form the three-dimensional detection area 1024. By means of the three-dimensional detection area 1024, a user can input the commands and complete the touch operation without using extra touch strength.

The present invention has been described with the above embodiments thereof and it is understood that many changes and modification in the above embodiment can be carried out without departing from the scope and the spirit of the invention that is intended to be limited only by the appended claims.

What is claimed is:

1. A touch device comprising:
a frame body having a first side, a second side, a third side and a fourth side, the third side being opposite to the first side, two ends of the first and third sides being respectively connected to the second and fourth sides;
multiple first transmitters disposed on the first side;
multiple first receivers disposed on the third side corresponding to the first transmitters respectively, the first transmitters and the first receivers together defining a horizontal detection area;
multiple second transmitters disposed on the second side;
multiple second receivers disposed on the fourth side corresponding to the second transmitters respectively, the second transmitters and the second receivers together defining a vertical detection area; and
a connection unit, a terminal of the connection unit being electrically connected to the first and second transmitters and the first and second receivers.

2. The touch device as claimed in claim 1, wherein the first and second transmitters transmit signals to the first and second receivers in an optical form for the first and second receivers to receive.

3. The touch device as claimed in claim 2, wherein the signals in the optical form are infrared signals.

4. The touch device as claimed in claim 1, wherein the horizontal detection area and the vertical detection area together form a three-dimensional detection area.

5. The touch device as claimed in claim 1, wherein the connection unit further has a plug-in terminal, which is selected from a group consisting of a USB connector, a 1394 connector, an HDMI connector and a digital audio/video connector.

6. The touch device as claimed in claim 1, wherein the first transmitters are distributed over the first side.

7. The touch device as claimed in claim 1, wherein the second transmitters are distributed over the second side.

8. The touch device as claimed in claim 1, wherein the first receivers are distributed over the third side.

9. The touch device as claimed in claim 1, wherein the second receivers are distributed over the fourth side.
